(19) United States
(12) Patent Application Publication
(10) Pub. No.: US 2008/0100044 A1
(43) Pub. Date: May 1, 2008

(54) Structure for guiding deploy of side airbag for seat of vehicle

(76) Inventor: Sam Jae Cho, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/647,457

(22) Filed: Dec. 27, 2006

(30) Foreign Application Priority Data
Oct. 31, 2006 (KR) 10-2006-0106440

(51) Int. Cl. B60R 21/207

(52) U.S. Cl. 280/730.2; 280/728.3

(57) ABSTRACT

A structure for guiding deploy of an airbag on a seat of a vehicle includes a sewing pattern at a side of a seat back that corresponds to a deploy direction of the airbag; a cover sewn together with the sewing pattern, an end of the cover extending toward an airbag module; and a secondary cover attached to the cover and mounted to the airbag module. The cover may have a greater tensile strength than a tensile strength of the seat cover. The connector may include a female part with a hooked end and a blocking protrusion, and a male part with a blocking protrusion configured to be inserted into the blocking protrusion of the female part.

### CROSS-REFERENCE TO RELATED APPLICATION

This application claims priority to and the benefit of Korean Patent Application No. 10-2006-0106440 filed in the Korean Intellectual Property Office on Oct. 31, 2006, the entire contents of which are incorporated herein by reference.

### BACKGROUND OF THE INVENTION

(a) Field of the Invention

The present invention relates to a structure for guiding deploy of a side airbag for a seat of a vehicle which enhances credibility of deploy performance of a side airbag.

(b) Description of the Related Art

A side airbag is generally mounted to an outer side of a seat and enclosed by a seat cover. In a side crash, an ECU sends a deploy signal to the side airbag. Since the airbag is covered by a seat cover, the airbag collides with the seat cover before it deploys to the outside, and accordingly, there is a time delay in the airbag deploy due to tensile strength of the seat cover. Furthermore, since the seat cover is not easily torn, the side airbag may break through a position other than the deploy position, so that deploy occurs inaccurately.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a structure for guiding deploy of a side airbag for a seat of a vehicle which enhances deploy performance and obtains a desired deploy pattern in a desired time.

An exemplary embodiment of the present invention provides a structure for guiding deploy of a side airbag for a seat of a vehicle which includes a space to which a sewing pattern is applied to a side of a seat back toward a deploy direction of an airbag cushion, wherein a cover for absorbing impact is sewn together with the sewing pattern of the seat cover at an inner side of the seat cover, and an end of the cover extends toward an airbag module and is connected to another cover which is mounted to the airbag module by a connector.

The cover may be made of material which has greater tensile strength than the seat cover.

The connector may include: a female part, an end of which is formed in a hook shape, with a blocking protrusion at an inner side of a center portion thereof; and a male part with a blocking protrusion thereof inserted into the blocking protrusion of the female part.

### BRIEF DESCRIPTION OF THE DRAWINGS

FIG. 1 is a perspective view of a seat of a vehicle in which a side airbag according to an exemplary embodiment of the present invention is installed.

FIG. 2 is a cross sectional view taken along a line A-A of FIG. 1.

FIG. 3 is a detailed view of a connecting member which is mounted between a first and a second cover according to an exemplary embodiment of the present invention.

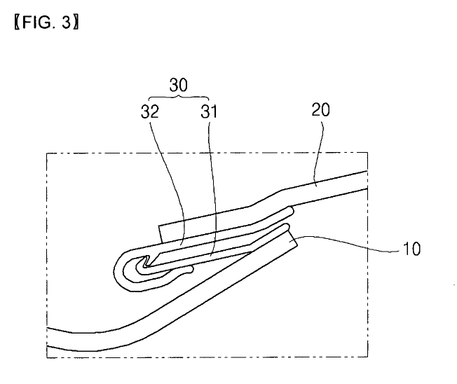

### DETAILED DESCRIPTION OF THE PREFERRED EMBODIMENTS

An exemplary embodiment of the present invention will hereinafter be described in detail with reference to the accompanying drawings.

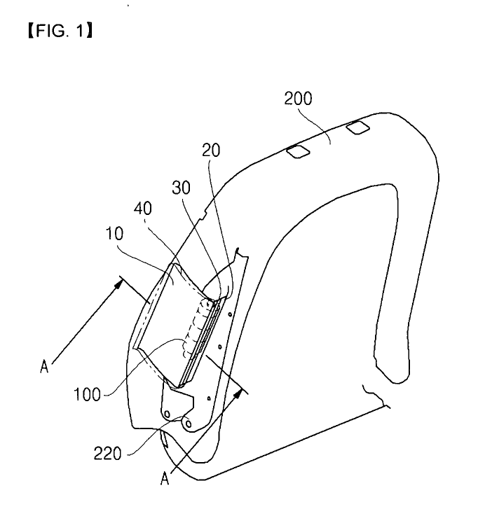

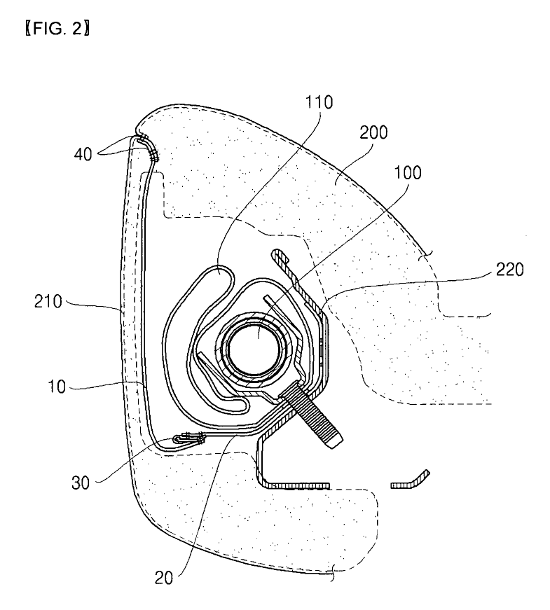

As shown in FIG. 1 and FIG. 2, an airbag module 100 which is mounted to a seat back frame 220 by a mounting member is configured to deploy toward the side of a seat back 200.

The side of the seat back 200 from which an airbag cushion 10 of the airbag module 100 deploys includes a sewing pattern 40 which is torn when the airbag cushion 10 deploys, and the sewing pattern 40 is regularly formed along a cut portion of the seat back 200.

A cover 10 which prevents time delay during the deploy of the airbag cushion 10 and also guides airbag cushion 110 so as to obtain a desired deploy shape is attached to the seat back 200, that is, an inner side of the seat cover 210. The cover 10 is sewn together with the seat cover 210 with the sewing pattern 40.

The cover 10 is made of material with a tensile strength greater than that of the seat cover, and an amount of expansion of the seat cover 210 of the seat back 200 which collides with the airbag cushion 110 when the airbag cushion 110 deploys is decreased by the cover 10.

An end of the cover 10 extends toward the airbag module 100 and is connected to the same, and the cover 10 is connected to a cover 20 which is mounted to the airbag module 100 using a connector 30, so that the cover 10 is supported.

The connector 30 is connected to a side of the cover 10 which is attached to the seat cover 210 and a side of the cover 20 which is integrally fixed to the airbag module 100 in a length direction thereof, and the connector 30 may be attached to the covers 10 and 20 by a mounting member.

The connector 30 is made of plastic material, and is formed by the coupling of a male part 31 which is provided to one side of the covers 10 and 20 and a female part 32 which is provided to the other side of the covers 10 and 20. When force greater than a threshold force acts on the cover 10, the connector 30 can elastically rotate.

An end portion of the female part 32 has a hook shape, and a blocking protrusion 32a is provided at an inner side of a center portion thereof. The male part 31 has a linear shape, and a blocking protrusion 31a is provided at an end portion thereof so as to be inserted to the blocking protrusion 32a of the female part 32.

So, an operating force of the cover can be supported by the blocking protrusions 31a and 32a.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A structure for guiding deploy of an airbag on a seat of a vehicle, comprising:
a sewing pattern at a side of a seat back that corresponds to a deploy direction of the airbag;
a cover sewn together with the sewing pattern, an end of the cover extending toward an airbag module; and
a secondary cover attached to the cover and mounted to the airbag module.

2. The structure of claim 1, wherein the cover has a greater tensile strength than a tensile strength of the seat cover.

3. The structure of claim 1, wherein the connector comprises:
a female part comprising a hooked end and a blocking protrusion; and
a male part comprising a blocking protrusion configured to be inserted into the blocking protrusion of the female part.
